(19) United States
(12) Patent Application Publication
(10) Pub. No.: US 2016/0146124 A1
(43) Pub. Date: May 26, 2016

(54) METHOD FOR CONTROLLING ELECTRICITY GENERATION MODE OF VEHICLE

(71) Applicants: HYUNDAI MOTOR COMPANY, Seoul (KR); KIA MOTORS CORPORATION, Seoul (KR)

(72) Inventor: Hwa Yong JANG, Hwaseong-si (KR)

(21) Appl. No.: 14/693,764

(22) Filed: Apr. 22, 2015

(30) Foreign Application Priority Data
Oct. 21, 2014 (KR) 10-2014-0142797

(51) Int. Cl. F02D 29/06; F02D 29/02

(52) U.S. Cl. CPC F02D 29/06; F02D 29/02

(57) ABSTRACT

A method for controlling an electricity generation mode of a vehicle includes detecting an idle condition of an engine. An electricity generation mode is performed in which a generator generates an electricity. An idle RPM is increased in the electricity generation mode. An managing mode is entered if the electricity generation mode time elapses a reference time. An engine RPM is increased or decreased for a predetermined time in the managing mode.

### CROSS-REFERENCE TO RELATED APPLICATION

This application claims the benefit of priority to Korean Patent Application No. 10-2014-0142797 filed in the Korean Intellectual Property Office on Oct. 21, 2014, the entire content of which is incorporated herein by reference.

### TECHNICAL FIELD

The present disclosure relates to a method for controlling electricity generation mode of a vehicle that prevents abrasion of an intake vale, an exhaust valve, or the like when an engine operates for a long period of time for generating electricity in an idle condition.

### BACKGROUND

An engine can operate in an idle condition for a long period of time as an electricity generator. When the engine operates in the idle condition for a long time to generate electricity, a specific engine component such as an intake valve and an exhaust valve may become worn out.

Further, when the engine operates for a long time and a vehicle is in a stationary state, because there is no change in travel distance, accurate maintenance or component replacement may not be achieved since engine components are replaced based on a travel distance.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide a method for controlling an electricity generation mode of a vehicle having advantages of reducing abrasion of a specific engine component of an engine when an engine enters into an idle condition in an electricity generation mode without moving, and controlling a rotational speed of an engine by entering a managing mode when an accumulation time of an electricity generation mode exceeds a predetermined time.

A method for controlling an electricity generation mode of a vehicle according to an exemplary embodiment of the present inventive concept may include detecting an idle condition of an engine. An electricity is generated by a generator in an electricity generation mode. An idle revolutions per minute RPM is increased in the electricity generation mode. A managing mode is entered if an electricity generation mode time elapses a reference time. An engine RPM is increased or decreased for a predetermined time in the managing mode.

The electricity generation mode may be performed in a D (drive) condition, a R (rear) condition, a N (neutral) condition, or a P (parking) condition of a transmission, and the RPM of the engine may be changed according to a condition of the transmission.

If it is determined that the engine RPM exceeds a reference RPM during the electricity generation mode, an accumulation time may be reset to zero.

The electricity generation mode or the managing mode may be performed by an electricity generation mode switch.

If it is determined that a total accumulation time of the managing mode exceeds a reference accumulation time, an emergency light may be turned on.

If it is determined that a total accumulation time of the managing mode exceeds a reference accumulation time, a replacement signal of an engine component may be generated according to the total accumulation time of the managing mode.

A system for controlling an electricity generation mode of a vehicle according to an exemplary embodiment of the present inventive concept includes an engine and an electricity generation mode switch. A generator is configured to generate an electricity. A battery has an inner side battery that is disposed inside the vehicle and an outer side battery that is disposed outside the vehicle. A controller is configured to control an engine RPM based on a driving condition of the engine of an operation of the electricity generation mode switch.

In accordance with the present disclosure, an electricity generation mode is performed and abrasion of engine components can be prevented by increasing an idle RPM of an engine, while the engine generates an electricity in an idle, parking, or a neutral condition while being stationary.

Further, if it is determined that an accumulation time of the electricity generation mode exceeds a reference accumulation time, a managing mode starts to periodically increase an engine RPM such that abrasion of a specific engine component is prevented. If it is determined that the accumulation time of the managing mode exceeds the reference accumulation time, a signal for replacing the specific engine component is generated for maintenance and A/S of a vehicle.

### BRIEF DESCRIPTION OF THE DRAWINGS

FIG. 1 is a schematic diagram showing an electricity generation system of a vehicle according to an exemplary embodiment of the present inventive concept.

FIG. 2 is a flowchart showing a method for controlling an electricity generation mode of a vehicle according to an exemplary embodiment of the present inventive concept.

FIG. 3 is a flowchart showing the method for controlling an electricity generation mode according to the exemplary embodiment of the present inventive concept.

FIG. 4 is a graph showing the method for controlling an electricity generation mode according to the exemplary embodiment of the present inventive concept.

### DETAILED DESCRIPTION

An exemplary embodiment of the present inventive concept will hereinafter be described in detail with reference to the accompanying drawings.

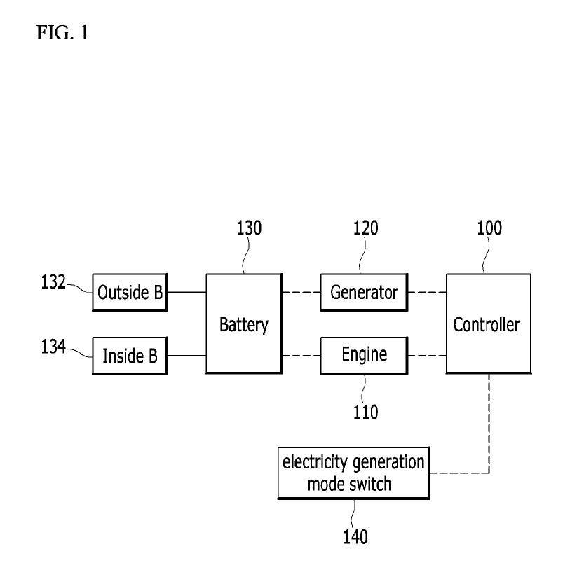

FIG. 1 is a schematic diagram showing an electricity generation system of a vehicle according to an exemplary embodiment of the present inventive concept.

Referring to FIG. 1, an electricity generation system of a vehicle includes controller 100, a generator 120, an engine 110, a battery 130, and an electricity generation mode switch 140. The battery 130 includes an inner side battery 134 that is disposed in the vehicle and an outer side battery 132 that is disposed outer side of the vehicle. The outer side battery 132 supplies electricity to an electricity consumer (not shown) that is disposed outside the outer side battery 132, and the inner side battery 134 supplies electricity to a motor (not shown) which is disposed inside the vehicle

When the engine 110 operates, the generator 120 uses torque of the engine 110 to generate the electricity of a predetermined voltage, and the generated electricity is stored in the battery 130. The electricity generation mode switch 140 can be operated by the controller 100 or a driver during a predetermined driving condition.

When the engine 110 operates in an idle condition and the generator 120 generates the electricity through the torque of the engine, the controller 100 changes a mode to increase revolutions per minute (RPM) of the engine 110 to a predetermined value through a predetermined logic.

In an exemplary embodiment of the present inventive concept, the controller 100 controls the RPM of the engine 110 based on a driving condition of the engine 110 or an operation of the electricity generation mode switch 140, and thus preventing the engine from being operated in the idle condition for a long period of time.

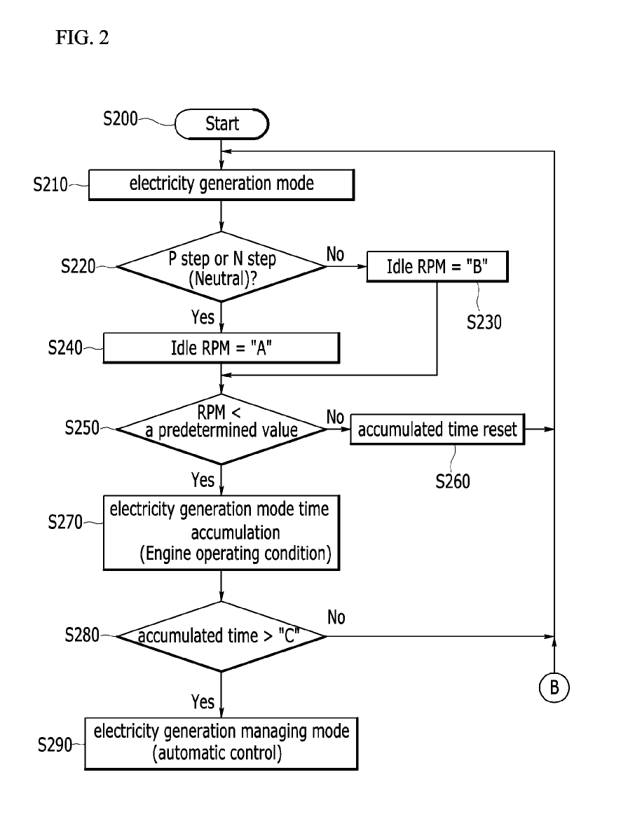

FIG. 2 is a flowchart showing a method for controlling an electricity generation mode of a vehicle according to an exemplary embodiment of the present Inventive concept.

Referring to FIG. 2, a control start in step S200, and an electricity generation mode is performed in step S210. The electricity generation mode can be automatically performed by the generator 120, or can be performed by the electricity generation mode switch 140. That is, when the generator 120 generates electricity by torque of the engine 110, the electricity generation mode can be performed, or the electricity generation mode can be performed by the electricity generation mode switch 140.

Whether a condition of a transmission (not shown) is in a D (drive), R (rear), P (parking), or N (neutral) state is determined in step S220.

Based on the condition of the transmission, an idle RPM of the engine is set to a value B in step S230, and the idle RPM of the engine is set to a value A in step S240. For example, the idle RPM is increased to 1500 RPM in the P state, and the idle RPM is increased to 120 RPM in the D, R, and N states.

Whether or not the RPM of the engine 110 is less than a predetermined value (e.g., 2000) is determined in step S250

If it is determined that the RPM of the engine 110 is less than the predetermined value, time for the electricity generation mode is accumulated in step S270. The time is accumulated while the engine 110 operates. If it is determined that the RPM of the engine 110 is higher than the predetermined value, the accumulation time is reset to 0 in step S260.

Further, whether the engine 110 is in a running state or not is determined in step S250, wherein the predetermined value can be set to 2000 or 3000 RPM in the S250.

Whether the accumulation time of the electricity generation mode is higher than a value C is determined in step S280. If the accumulation time of the electricity generation mode is higher than the value C, a managing mode is performed in step S290.

The RPM of the engine 110 is increased periodically in the managing mode, and thus, the engine is operated at inconsistent rotational speed.

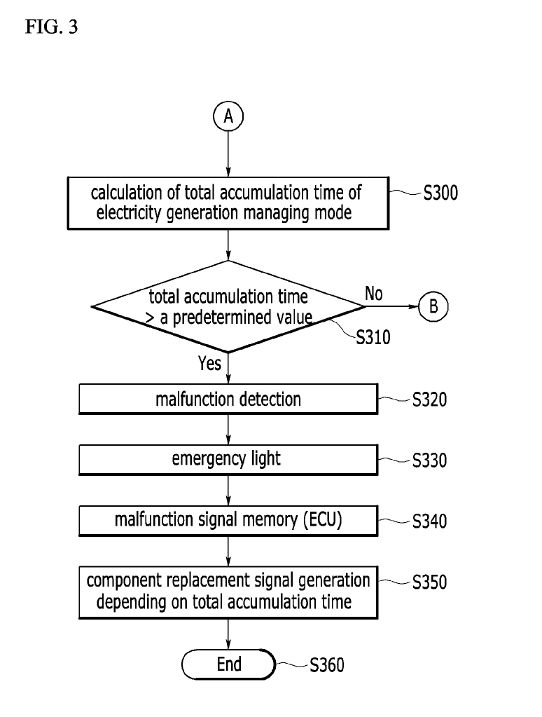

FIG. 3 is a flowchart showing a method for controlling an electricity generation mode of a vehicle according to an exemplary embodiment of the present inventive concept.

Referring to FIG. 3, time for the managing mode is accumulated in step S300, and it is determined whether the accumulation time of the managing mode is higher than a predetermined value.

If the accumulation time is less than the predetermined value in step S310, step S210 is performed. If the accumulation time is higher than the predetermined value in step S310, a malfunction is detected in step S320, an emergency lamp is turned on, a malfunction signal is memorized in step S340, and a replacement signal is generated to inform replacement of an engine component based on the accumulation time in step S350. Then, the process ends in step S360.

The engine component may be an intake valve or an exhaust valve, and may be all kinds of elements of a vehicle as well as oil type.

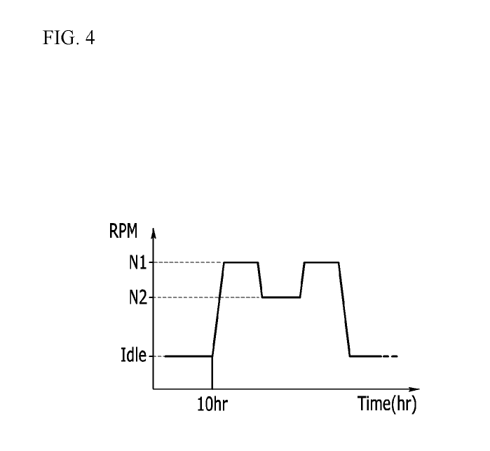

FIG. 4 is a graph showing a method for controlling an electricity generation mode of a vehicle according to an exemplary embodiment of the present inventive concept.

Referring to FIG. 4, a horizontal axis denotes a vertical axis, and a vertical axis denotes a rotational speed (RPM) of the engine 110. If the electricity generation mode continues for a predetermined time (e.g., 10 hours), the RPM of the engine increases to N1 (e.g., 1500 RPM) in an idle condition.

After the predetermined time elapses, the RPM of the engine 110 is controlled to be N2 (e.g., 1200 RPM), and the RPM of the engine 110 is increases to N1 to be the original idle value.

In an exemplary embodiment of the present inventive concept, when a vehicle is stationary and while generating electricity in an idle state, an intake valve or an exhaust valve may be worn out, and therefore, durability of the valves can be deteriorated.

However, because the vehicle does not move and the engine generates the electricity in the idle condition, there is no change in travel distance, and therefore, a user may not aware of any engine problem.

According to an exemplary embodiment of the present inventive concept, when the vehicle does not move in a P or a N state of a transmission and the engine continuously generates the electricity, a controller enters an electricity generation managing mode to raise rotational speed (idle speed) of the engine to prevent abrasion of engine components.

If a total accumulation time of the managing mode exceeds a predetermined value, a replacement signal corresponding to a predetermined component is generated to inform a user for maintenance.

While this inventive concept has been described in connection with what is presently considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling an electricity generation mode of a vehicle, the method comprising steps of:
detecting an idle condition of an engine;
generating an electricity by a generator in an electricity generation mode;
increasing an idle revolutions per minute (RPM) in the electricity generation mode;
entering an electricity generation managing mode if an electricity generation mode time elapses a reference time; and
increasing or decreasing an engine RPM for a predetermined time in the electricity generation managing mode.

2. The method of claim 1, wherein the electricity generation mode is performed in a D (drive) condition, a R (rear) condition, a N (neutral) condition, or a P (parking) condition of a transmission, and the engine RPM is changed according to a condition of the transmission.

3. The method of claim 1, wherein if it is determined that the engine RPM exceeds a reference RPM in the electricity generation mode, an accumulation time is reset to 0 (zero).

4. The method of claim 1, wherein the electricity generation mode or the electricity generation managing mode is selected by an electricity generation mode switch.

5. The method of claim 1, wherein if it is determined that a total accumulation time of the electricity generation managing mode exceeds a reference accumulation time, an emergency light is turned on.

6. The method of claim 1, wherein if it is determined that a total accumulation time of the electricity generation managing mode exceeds a reference accumulation time, a replacement signal for an engine component is generated according to the total accumulation time of the managing mode.

7. A system for controlling an electricity generation mode of a vehicle, the system comprising:
an engine;
an electricity generation mode switch;
a generator configured to generate an electricity;
a battery having an inner side battery that is disposed inside the vehicle and an outer side battery that is disposed outside the vehicle; and
a controller configured to control an engine RPM based on a driving condition of the engine of an operation of the electricity generation mode switch.
